(19) United States
(12) Patent Application Publication
(10) Pub. No.: US 2003/0136877 A1
(43) Pub. Date: Jul. 24, 2003

(54) Aircraft with means for at least reducing impact against a ground

(76) Inventors: Mark Chak, Brooklyn, NY (US); Alexander Chak, Brooklyn, NY (US)

Correspondence Address: Ilya Zborovsky, 6 Schoolhouse Way, Dix Hills, NY, 11746, US

(21) Appl. No.: 10/054,191

(22) Filed: Jan. 24, 2002

(51) Int. Cl. B64C 25/00

(52) U.S. Cl. 244/100 R

(57) ABSTRACT

An aircraft has an aircraft part with a drive means and a body; and device for reducing impact of the aircraft against the ground, the device being movable between an inoperative position which it is located close to the body and an operative position in which it is moved from the body so as to provide dampening of aircraft when it hits the ground.

### BACKGROUND OF THE INVENTION

The present invention relates to an aircraft with means for at least reducing impact against the ground.

It is known that aircrafts are prone to accidents, in which case the aircraft falls on the ground and is destroyed with subsequent death of aircraft occupants. It is therefore believed to be important to develop means for at least reducing the impact of the aircraft against the ground so as to save human lives.

### SUMMARY OF THE INVENTION

Accordingly, it is an object of the present invention to provide an aircraft which has better changes for reducing impact against the ground and therefore saves human lives.

In keeping with these objects and with others which will become apparent hereinafter, one feature of the present invention resides, briefly stated, in an aircraft which has an aircraft part with driving means and a body; and an impact reducing device which is movable between an inoperative position in which it is hidden in the body and an operative position in which it is moved out of the body so as to first be subjected to impact against the ground and to dampen the impact.

When the aircraft is designed in accordance with the present invention, it at least reduces the spans of impact of the aircraft against the ground and therefore can save human lives.

### BRIEF DESCRIPTION OF THE DRAWINGS

FIG. 1 is a view showing an aircraft with means for reducing impact against the ground in accordance with the present invention;

FIG. 2 is a view substantially corresponding to the view of FIG. 1 by showing another embodiment of the present invention;

FIG. 3 is a view substantially corresponding to the view of FIG. 1, but showing still a further embodiment of the present invention.

### DESCRIPTION OF THE PREFERRED EMBODIMENTS

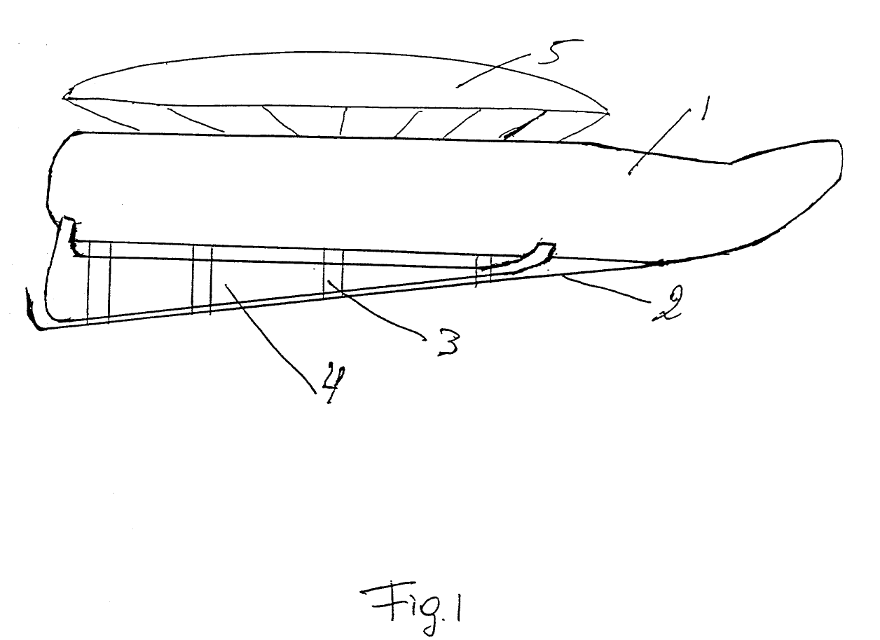

An aircraft in accordance with the present invention is identified with reference numeral 1. It has a device for reducing an impact against the ground. The device includes a part which is identified with reference numeral 2 and can be movable in an inoperative position in which it is located close to a lower surface of the body of the aircraft or is even introduced in a cavity in the inner surface, and an operative position in which it moves downwardly in FIG. 1 to reduce impact of the aircraft against the count. The device 2 can be formed as skies, a sliding surface, etc. shock adsorbing means such as for example individual sock absorbers 3 are provided between the body of the aircraft 1 and the element 2. An air cushion 4 is further provided also between the body of the aircraft and the element 2. The air cushion can be formed either as a single enclosed cushion or as a cushion provided with an inner cushion which can be provided with another inner cushion, so that if the outside cushion is broken, the inside cushion still remains operative. The device 2, 3, 4, can be activated for example by a pilot when the aircraft uses altitude or can be activated by a fast lowering of the aircraft in the case of an accident, etc.

When the aircraft hits the ground with the device shown in FIG. 1, the shock absorbers 3 absorb the shock, the air cushion 4 also absorbs the shock, since the aircraft first hits the ground with the element 2 in its extended position and the shock absorbers 3 and in the air cushions 4 between the element 2 in the body of the aircraft.

As can be seen from FIG. 1, in order to orient the aircraft so that it falls on the ground by its lower surface with the device 2, 3, 4, facing the ground, a parachute 5 is attached to the aircraft which allows falling the aircraft with the bottom facing down.

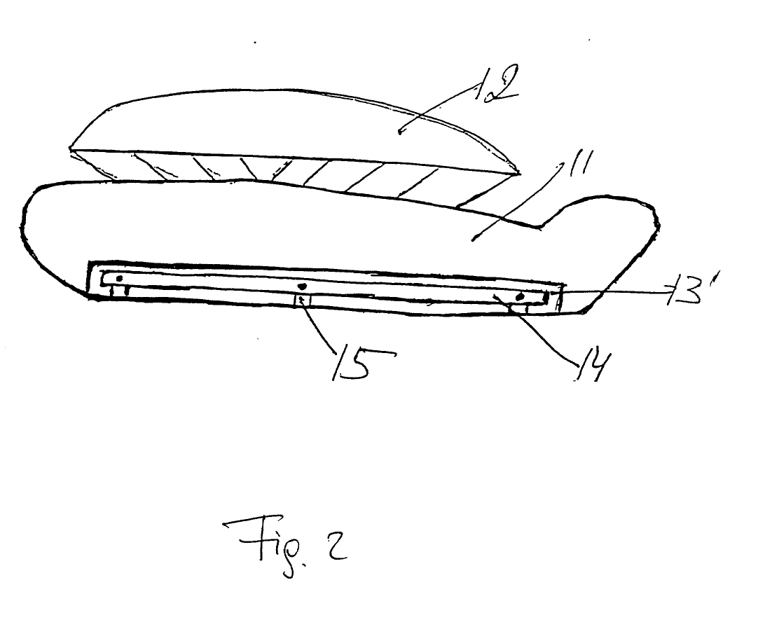

FIG. 2 shows another modification of the present invention.

In the embodiment of FIG. 1 the aircraft 11 is provided with a parachute 12. In the lower part of the aircraft body there is a recess 13 which houses dampening element sections such as mattresses composed of a dampening material, such as rubber, hey, etc. 14. Reference numeral 15 identifies guides for sliding the mattresses to the lower part of the body. In the event of accident, the mattresses 14 are moved outwardly beyond the body of the aircraft and reduce the impact of the aircraft against the ground.

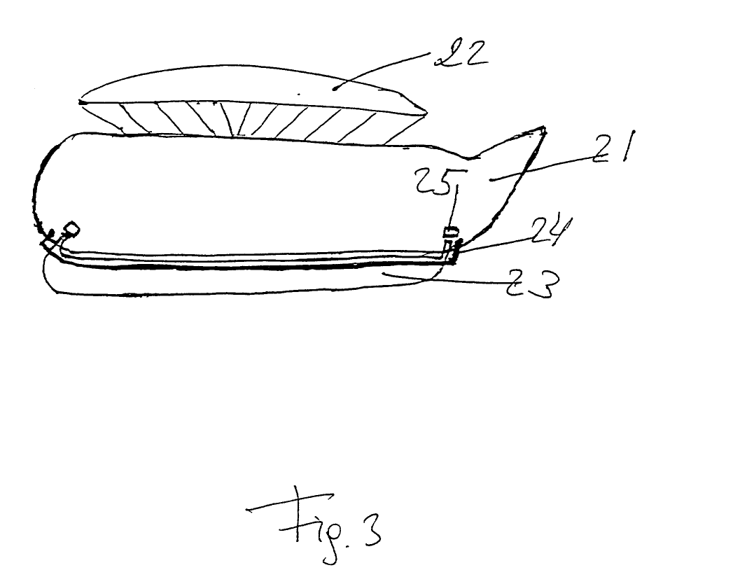

In the embodiment of FIG. 3 the aircraft 21 is provided again with the parachute 22. An air cushion 3 formed as a single air cushion for a plurality of air cushions located in one another is accommodated in a recess 4 and provided with an inflating pump 5. When the air cushion is released from the recess it is inflated by the pump. If the outermost air cushion is broken, the inner air cushions reduce the impact.

The above mentioned additional means for reducing the impact also serve as floating means if the aircraft falls on a water surface, in addition to reducing the strength of the impact. It is also possible to provide aircraft with a double body, so that in the event of the impact the outer body is dampening means is destroyed, or in the inner body remains substantially intact.

It will be understood that each of the elements described above, or two or more together, may also find a useful application in other types of constructions differing from the types described above.

While the invention has been illustrated and described as embodied in aircraft with means for at least reducing impact against a ground, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. An aircraft, comprising an aircraft part with a drive means and a body; and device for reducing impact of the aircraft against the ground, said device being movable between an inoperative position which it is located close to said body and an operative position in which it is moved from the body so as to provide dampening of aircraft when it hits the ground.

2. An aircraft as defined in claim 1, wherein said body is provided with a recess formed so that in said inoperative position said device is located inside said recess, while in said operative position said device is moved outside of said recess.

3. An aircraft as defined in claim 1, wherein said device is formed so that in said inoperative position it is located so as to abut against said body, while in said operative position it is moved from said body.

4. An aircraft as defined in claim 1, wherein said device includes an inflatable element so as to dampen the impact of the aircraft against the ground.

5. An aircraft as defined in claim 4, wherein said inflatable element is composed of a plurality of inflatable elements located one inside the other.

6. An aircraft as defined in claim 1, wherein said device includes an element formed as a mattress with a dampening material.

7. An aircraft as defined in claim 1, wherein said device includes shock adsorbing means.

8. An aircraft as defined in claim 1, wherein said device includes an element movable away from said body and absorbing means located between said element and said body.

9. An aircraft as defined in claim 1, wherein said device includes an inflatable element, a pumping means for inflating said inflatable element.

10. An aircraft as defined in claim 1; and further comprising parachute means for reducing a speed of falling of the aircraft in the event of an accident and also orienting the aircraft so that it falls with its bottom oriented toward the ground.
